(19) United States
(12) Patent Application Publication
(10) Pub. No.: US 2015/0331298 A1
(43) Pub. Date: Nov. 19, 2015

(54) SEMICONDUCTOR OPTICAL INTEGRATED DEVICE

(71) Applicant: SUMITOMO ELECTRIC INDUSTRIES, LTD., Osaka (JP)

(72) Inventor: HIDEKI YAGI, Machida-shi (JP)

(73) Assignee: SUMITOMO ELECTRIC INDUSTRIES, LTD., Osaka (JP)

(21) Appl. No.: 14/704,725

(22) Filed: May 5, 2015

(30) Foreign Application Priority Data
May 13, 2014 (JP) 2014-099704

(51) Int. Cl. G02F 1/225

(52) U.S. Cl. CPC G02F 1/2257; G02F 2001/212

(57) ABSTRACT

A semiconductor optical integrated device including: a substrate having a first area, a second area and a third area arranged in a waveguiding direction; a laser portion disposed on the third area the laser portion including a laser waveguide and a heater thereon; a semiconductor waveguide disposed on the second area, the semiconductor waveguide including a core layer and a cladding layer disposed on the core layer; a Mach-Zehnder modulator portion disposed on the first area, the Mach-Zehnder modulator portion including a first arm and a second arm; a buried region embedding the laser waveguide, the semiconductor waveguide, and the first and second arms; a groove disposed on the second area, the groove extending in a direction intersecting the waveguiding direction to across the semiconductor waveguide to the buried region; and a resin body disposed on the Mach-Zehnder modulator portion. The laser portion is optically coupled to the Mach-Zehnder modulator portion via the semiconductor waveguide. The groove has a bottom on a surface of the core layer of the semiconductor waveguide.

### BACKGROUND OF THE INVENTION

1. Field of the Invention

The present invention relates to semiconductor optical integrated devices.

2. Description of the Related Art

Patent Literature 1 (Japanese Unexamined Patent Application Publication No. 2008-010484) discloses a semiconductor optical device in which a laser section and an optical modulator section are monolithically integrated. In the semiconductor optical device of Patent Literature 1, the optical modulator region has a ridge waveguide structure buried with an organic insulating material. The laser section has a ridge waveguide structure in which peripheral regions of the mesa are not buried in an organic insulating material or a semiconductor, namely, the side surfaces of the ridge waveguide structure are exposed to air, Patent Literature 2 (Japanese Unexamined Patent Application Publication No. 2013-033892) discloses a wavelength-tunable laser. In wavelength-tunable lasers, the refractive index of optical waveguides is changed to tune the wavelength. In the laser section of Patent Literature 2, the refractive index is changed by, for example, controlling the temperature of the waveguides with heaters.

The wavelength-tunable laser of Patent Literature 2 is manufactured as an individual device without being integrated with an optical modulator. For example, the side surfaces of the waveguides of the wavelength-tunable laser of Patent Literature 2 are buried with semiconductor layers. On the other hand, waveguides of an optical modulator have to be made with a high dimensional accuracy and therefore it is preferable that the side surfaces of the waveguides be not buried with semiconductors. That is, wavelength-tunable lasers and optical modulators have a difference in terms of preferred waveguide structures. This difference becomes a barrier to monolithically integrating a wavelength-tunable laser and an optical modulator on a single substrate. In the wavelength-tunable laser of Patent Literature 2, the waveguides are subjected to temperature changes with heaters in order to alter wavelengths, On the other hand, waveguides of an optical modulator are preferably maintained at a constant temperature to perform stable modulation. This difference in waveguide temperature requirements obstructs the monolithic integration of a wavelength-tunable laser and an optical modulator on a single substrate.

### SUMMARY OF THE INVENTION

A semiconductor optical integrated device according to an aspect of the present invention includes a substrate having a principal surface including a first area, a second area and a third area extending along a waveguiding direction; a laser portion disposed on the third area of the substrate, the laser portion including a laser waveguide that includes an active section configured to generate light and a passive section including a heater thereon; a semiconductor waveguide disposed on the second area of the substrate, the semiconductor waveguide including a core layer and a cladding layer disposed on the core layer; a Mach-Zehnder modulator portion disposed on the first area of the substrate, the Mach-Zehnder modulator portion including a first multi-mode interference (MMI) coupler, a first arm, a second arm, a second MMI coupler, a first electrode and a second electrode; a buried region embedding the laser waveguide, the semiconductor waveguide, and the first and second arms of the Mach-Zehnder modulator portion; a groove disposed on the second area of the substrate, the groove extending in a direction intersecting the waveguiding direction to across the semiconductor waveguide to the buried region; and a resin body disposed on the Mach-Zehnder modulator portion. The laser portion is optically coupled to the Mach-Zehnder modulator portion via the semiconductor waveguide. The groove has a bottom on a surface of the core layer of the semiconductor waveguide,

Objects, features and advantages of the present invention will be understood more easily based on the following detailed description illustrating preferred embodiments of the invention with reference to the accompanying drawings.

### BRIEF DESCRIPTION OF THE DRAWINGS

FIGS. 1A and 1B are views schematically illustrating a structure of a semiconductor optical integrated device according to an embodiment.

FIGS. 2A and 2B are views illustrating buried structures in MMI couplers and arm waveguides in a Mach-Zehnder modulator portion according to an embodiment.

FIGS. 3A to 3C are views schematically illustrating principal steps in a method for manufacturing a semiconductor optical integrated device according to an embodiment.

FIGS. 4A to 4C are views schematically illustrating principal steps in a method for manufacturing a semiconductor optical integrated device according to an embodiment.

FIG. 5 is a view schematically illustrating principal steps in a method for manufacturing a semiconductor optical integrated device according to an embodiment.

FIG. 6 is a view schematically illustrating principal steps in a method for manufacturing a semiconductor optical integrated device according to an embodiment.

FIGS. 7A to 7D are views schematically illustrating principal steps in a method for manufacturing a semiconductor optical integrated device according to an embodiment.

FIG. 8 is a view schematically illustrating principal steps in a method for manufacturing a semiconductor optical integrated device according to an embodiment.

FIGS. 9A to 9D are views schematically illustrating principal steps in a method for manufacturing a semiconductor optical integrated device according to an embodiment.

FIG. 10 is a view schematically illustrating principal steps in a method for manufacturing a semiconductor optical integrated device according to an embodiment.

FIGS. 11A to 11D are views schematically illustrating principal steps in a method for manufacturing a semiconductor optical integrated device according to an embodiment.

FIG. 12 is a view schematically illustrating principal steps in a method for manufacturing a semiconductor optical integrated device according to an embodiment.

### DESCRIPTION OF THE PREFERRED EMBODIMENTS

Some embodiments will be described hereinbelow.

A semiconductor optical integrated device according to an embodiment includes (a) a substrate having a principal surface including a first area, a second area and a third area arranged in a waveguiding direction; (b) a laser portion disposed on the third area of the substrate, the laser portion including a laser waveguide that includes an active section configured to generate light and a passive section including a heater thereon; (c) a semiconductor waveguide disposed on the second area of the substrate, the semiconductor waveguide including a core layer and a cladding layer disposed on the core layer; (d) a Mach-Zehnder modulator portion disposed on the first area of the substrate, the Mach-Zehnder modulator portion including a first MMI coupler, a first arm, a second arm, a second MMI coupler, a first electrode and a second electrode; (e) a buried region embedding the laser waveguide, the semiconductor waveguide, and the first and second arms of the Mach-Zehnder modulator portion; (f) a groove disposed on the second area of the substrate, the groove extending in a direction intersecting the waveguiding direction to across the semiconductor waveguide to the buried region; and (g) a resin body disposed on the Mach-Zehnder modulator portion. The laser portion is optically coupled to the Mach-Zehnder modulator portion via the semiconductor waveguide. The groove has a bottom on a surface of the core layer of the semiconductor waveguide.

In the semiconductor optical integrated device, the laser portion and the Mach-Zehnder modulator portion are monolithically integrated on the substrate. in the semiconductor optical integrated device, the semiconductor waveguide is disposed to provide an optical coupling between the laser portion and the Mach-Zehnder modulator portion, and the groove extends across the cladding layer of the semiconductor waveguide. The groove is disposed between the laser portion and the Mach-Zehnder modulator portion to separate the laser portion and the Mach-Zehnder modulator portion thermally from each other. The groove is disposed so as to across the semiconductor waveguide to the buried region. With this configuration, the heat propagating from the heater of the laser portion to the Mach-Zehnder modulator portion is decreased. The groove has the bottom on the surface of the core layer of the semiconductor waveguide. With this configuration, the optical coupling of the laser portion and the Mach-Zehnder modulator portion is maintained.

In an embodiment of the semiconductor optical integrated device, the first MIMI coupler may be optically coupled to one end of the first arm and one end of the second arm. The second MMI coupler may be optically coupled to the other end of the first arm and the other end of the second arm. The buried region may include a first trench and a second trench, the first trench and the second trench each defining one side surface and the other side surface of the first arm. The buried region may include a third trench and a fourth trench, the third trench and the fourth trench each defining one side surface and the other side surface of the second arm. The first electrode and the second electrode may be connected to the first arm and the second arm via a first opening and a second opening in the resin body, respectively.

In this semiconductor optical integrated device, electrical signals are applied to the first and second arms of the Mach-Zehnder modulator portion by the first and the second electrode. Because these arms are embedded in the buried region, the leak current relating to the side surfaces of the first and second arms are reduced. The buried regions include the trenches that define the side surfaces of the first and second arms. These trenches contribute to increase the uniformity of the thickness of the resin body formed on the first and second arms, Openings are formed in the resin body on the first and second arms. As the thickness of the resin body is uniform on the first and second arms, the first and second openings are formed uniformly. Thus, it is possible to produce a plurality of Mach-Zehnder modulators on a single wafer or with different production lots with high reproducibility.

In an embodiment of the semiconductor optical integrated device, the buried region is made of Fe-doped InP. According to this semiconductor optical integrated device, the Fe-doped InP contributes to reduce a dark current at the first and second arms,

In an embodiment of the semiconductor optical integrated device, the buried region on the side surfaces of the first and second arms has a thickness of 0.3 μm to 0.5 μm. According to this semiconductor optical integrated device, the thickness of 0.3 μm to 0.5 μm allows for both the reduction of dark current and the decrease in parasitic capacitance of the Mach-Zehnder modulator portion.

In an embodiment of the semiconductor optical integrated device, the first MMI coupler and the second MMI coupler of the Mach-Zehnder modulator portion are buried with the resin body. According to this semiconductor optical integrated device, the laser waveguides, the semiconductor waveguides, the first and second arms are embedded in the buried regions, whereas the first MMI coupler and the second MMI coupler are not embedded in the buried regions. This configuration makes it possible to prevent the dimensions of the MMI couplers from being out of the designs due to the buried region. That is, the dimensions of the MMI couplers are only dependent on the accuracy of dry etching. The MMI couplers having accurate dimensions maintain good optical characteristics. Further, good optical characteristics of the MMI couplers arc maintained because of the large difference in refractive index between the semiconductors constituting the MMI couplers and the resin body.

In an embodiment of the semiconductor optical integrated device, the bottom of the groove reaches an upper surface of the core layer of the semiconductor waveguide. According to this semiconductor optical integrated device, the groove is formed to a depth that reaches the core layer, but not intersects the core layer. The groove having this depth, the amount of heat propagating from the heater to the Mach-Zehnder modulator portion is decreased. In addition, the optical loss due to the groove can be suppressed,

In an embodiment of the semiconductor optical integrated device, the resin body has a lower refractive index than a refractive index of the core layer, the resin body has a lower thermal conductivity than a thermal conductivity of the buried regions, and the resin body is disposed in the groove. According to this semiconductor optical integrated device, the optical loss due to the presence of the groove is suppressed.

The findings according to the present invention are easily understood based on the following detailed description with reference to the accompanying drawings given as examples. Hereinbelow, embodiments of the semiconductor optical integrated devices of the invention will be described with reference to the accompanying drawings. Where possible, the same reference numerals will be used for equivalent features,

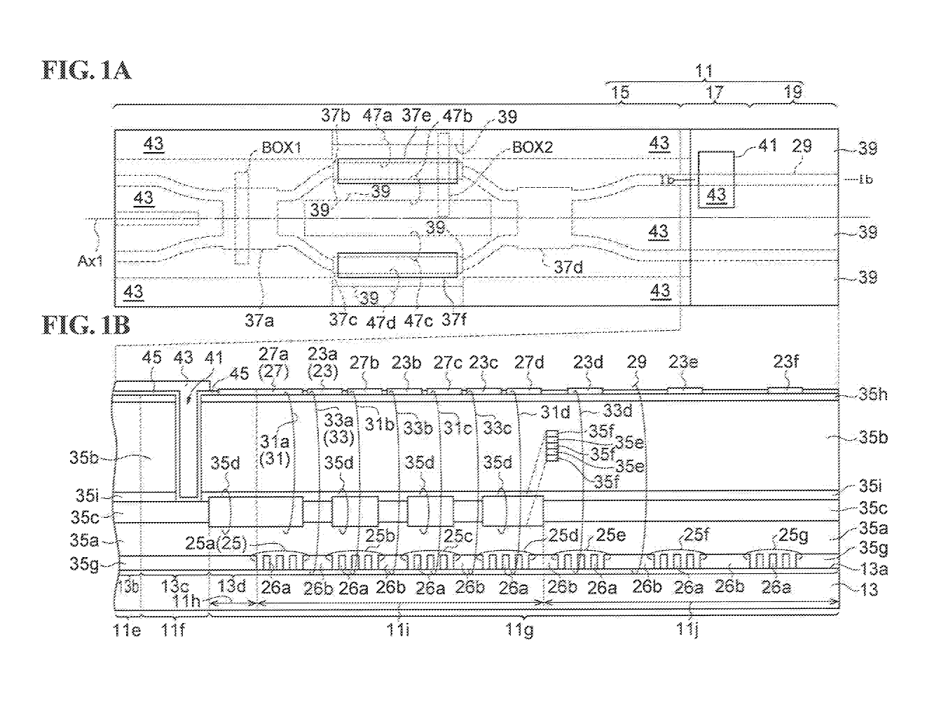

FIGS. 1A and 1B are views schematically illustrating a structure of a semiconductor optical integrated device according to the present embodiment, FIG. 1A is a plan view illustrating a Mach-Zehnder modulator portion 15, semiconductor waveguides 17 and a laser portion 19, FIG. 1B illustrates a cross section taken along line 1b-1bin FIG. 1A. A semiconductor optical integrated device 11 includes a Mach-Zehnder modulator portion 15, semiconductor waveguides 17 and a wavelength-tunable laser portion 19. The Mach-Zehnder modulator portion 15, the semiconductor waveguides 17 and the laser portion 19 are disposed on a semiconductor substrate 13. The substrate 13 has a principal surface 13a. The principal surface 13a includes a first area 131, a second area 13c and a third area 13d, in the present embodiment, the first area 13b, the second area 13c and the third area 13d are arranged in a first axial Ax1 direction (waveguiding direction). The Mach-Zehnder modulator portion 15 is disposed on the first area 13b of the substrate 13. The semiconductor waveguides 17 are disposed on the second area 13c of the substrate 13. The laser portion 19 is disposed on the third area 13d of the substrate 13. The laser portion 19 is optically coupled to the Mach-Zehnder modulator portion 15 via the semiconductor waveguides 17. More specifically, the semiconductor optical integrated device 11 includes a first region 11e, a second region 11f and a third region 11g, and these regions are arranged in the first axial Ax1 direction. The first region lie includes the

Mach-Zehnder modulator portion 15, the second region 11f includes the semiconductor waveguides 17, and the third region 11g includes the laser portion 19.

The laser portion 19 includes heaters 23 (23a, 23b, 23c, 23d, 23e and 23f), a segmented grating 25 (gratings 25a, 25b, 25e, 25d, 25e, 25f and 25g), electrodes 27 (27a, 27b, 27c and 27d), and laser waveguides 29. The laser waveguide 29 includes one or more active waveguide sections 31 (31a, 31b, 31c, and 31d), and one or more passive waveguide sections 33 (33a, 33b, 33c and 33d). The electrodes 27 (27a, 27b, 27e and 27d) of the laser portion 19 are connected to the active waveguide sections 31 of the laser waveguide 29. The active waveguide sections 31 (31a to 31d) generate light in response to current injection from the electrodes 27 (27a, 27h, 27c and 27d). The heaters 23 are disposed in contact with the surface of the passive waveguide sections 33 (33a, 33h, 33c and 33d). The passive waveguide sections 33 (33a, 33b, 33c and 33d) produce a refractive index change in response to heat generated by the heaters 23. For example, the heaters 23 include NiCrSi.

The third region 11g includes a sampled grating distributed feedback region (hereinafter, “SG-DFB region”) 11i and a chirped sampled grating distributed Bragg reflector region (hereinafter, “CSG-DBR region”) 11j. In an embodiment, the third region 11g includes a semiconductor optical amplifier region (hereinafter, “SOA region”) 11h. In the SG-DFB region 11i, the active waveguide sections 31 and the passive waveguide sections 33 are arranged alternately, and the SG-DFB region 11i has an optical gain. The SG-DFB region 11 provides a gain spectrum having periodic peaks with respect to wavelengths. The CSG-DBR region 11j constitutes a reflector in a cavity of the semiconductor laser. The CSG-DBR region 11j provides a reflection spectrum having periodic peaks with respect to wavelengths.

The grating 25 includes a plurality of sampled gratings 25a, 25b, 25e, 25d, 25e, 25f and 25g. The sampled gratings 25a to 25g are arranged along the laser waveguide 29 while being separate from one another, and are optically coupled to the active waveguide sections 31 and the passive waveguide sections 33. For example, the sampled gratings 25a to 25g may be corrugation gratings.

In the SG-DFB region 11i and the CSG-DBR region 11j, the sampled gratings 25a to 25g are disposed. The grating 25 in the SG-DFB region 11i and the CSG-DBR region 11j is composed of a plurality of segments. The segments include first segments 26a and second segments 26b. Each of the first segments 26a has a single sampled grating (any one of the sampled gratings 25a to 25g). The second segments 26b do not include sampled gratings, and each second segment 26b is interposed between the first segments 26a. The arrangement of the plurality of segments constitutes a reflector. The SG-DFB region 11i includes a plurality of segments, and the segments have an identical optical length. The CSG-DBR. region 11j includes a plurality of segments. The segments in the CSG-DBR region 11j have an optical length different from that of the segments in the SG-DFB region 11i. Thus, the sampled gratings 25a to 25g in the SG-DFB region 11i and the CSG-DBR region 11, are arranged to have a plurality of grating periods. The CSG-DBR region 11j can provide a reflection spectrum having periodic peaks with respect to wavelengths. More specifically, the CSG-DBR region 11j is such that the plurality of sampled gratings is arranged with chirped periods. As a result, a reflection spectrum of the CSG-DBR region shows a wavelength dependency in which a plurality of reflection peaks forms an envelope. The wavelengths of the reflection peaks in the reflection spectrum are changed depending on the heat generated by the heaters 23. Utilizing the Vernier effect between the change in the reflection spectrum and the gain spectrum, it becomes possible to alter the emission wavelength of the semiconductor laser.

An example of the structure of the SG-DFB region 11i is shown below. In the refractive index modifying regions, the lower cladding layer 35a is n-type InP, the upper cladding layer 35b is p-type InP, and the core layer 35c is an InGaAsP bulk layer (1.4 μm). In the optical gain regions, the lower cladding layer 35a is n-type InP, the upper cladding layer 35b is p-type InP, and, in the quantum well structures (alternate stacks of well layers and barrier layers) 35d, the well layers 35e are GaInAsP (thickness: 5 nm, Ga ratio: 0.32, In ratio: 0.68), and the barrier layers 35f are GaInAsP (thickness: 10 nm, Ga ratio: 0.22, In ratio; 0.78). The bandgap of the well layers 35e is smaller than the bandgap of the barrier layers 35f. The outermost barrier layer may be an optical confinement layer. The contact layer 35h is p-type GaInAs. in the refractive index modifying regions and the optical gain regions, the semiconductor substrate 13 is an n-type InP crystal substrate, the grating layer 35g is GaInAsP (bandgap wavelength: 1.3 μm), and the semiconductor layer 35i is undoped InP. The grating 25 is made using the difference in refractive index between the grating layer 35g and the lower cladding layer 35a. The refractive index modifying regions and the optical gain regions are connected to each other by butt-joint coupling. The semiconductor waveguides 17 include the core layer 35c disposed on the lower cladding layer 35a, and the upper cladding layer 35b is disposed on the core layer 35c. The sampled gratings 25a to 25g are optically coupled to the core layer 35c and the quantum well structures 35d.

The Mach-Zehnder modulator portion 15 includes a first multi-mode interference (first MMI) coupler 37a, a first arm waveguide (first arm) 37b, a second arm waveguide (second arm) 37c, a second multi-mode interference (second MMI) coupler 37d, a first modulating electrode 37e and a second modulating electrode 37f. The first MMI coupler 37a has ports for providing modulated light. These ports are optically coupled to output ports of the semiconductor optical integrated device 11. One end of the first arm 37b and one end of the second arm 37c are connected to the respective ports of the first MMI 37a. The other end of the first arm 37b and the other end of the second arm 37c are connected to the respective ports of the second MMI 37d. The second MMI 37d receives the laser light from the laser portion 19 via the semiconductor waveguides 17. The first electrode 37e and the second electrode 37f are connected to the first arm 37b and the second arm 37c, respectively.

The semiconductor optical integrated device 11 further includes buried semiconductor regions 39 disposed to bury the semiconductor waveguides 17 and the laser waveguides 29. In the buried regions 39, the laser waveguides 29 are buried, in the semiconductor optical integrated device 11, a groove 41 is disposed in the semiconductor waveguide 17 and the buried regions 39. The semiconductor waveguide 17 extends along the first direction Ax1. The groove 41 extends in a direction intersecting with the first direction Ax1, and across the semiconductor waveguide 17 to the buried region 39. In the present embodiment, the groove 41 extends across the upper cladding layer 35b of the semiconductor waveguide 17. For example, the buried regions 39 is made of Fe-doped InP.

The semiconductor optical integrated device 11 further includes a resin body 43 disposed on the Mach-Zehnder modulator portion 15. For example, the resin body 43 includes bisbenzocyclobutene (BCB) resin.

In the semiconductor optical integrated device 11, the Mach-Zehnder modulator portion 15 and the laser portion 19 are monolithically integrated on a single semiconductor substrate. In this semiconductor optical integrated device 11, the semiconductor waveguide 17 is disposed between the Mach-Zehnder modulator portion 15 and the laser portion 19. The semiconductor waveguide 17 optically couples the Mach-Zehnder modulator portion 15 and the laser portion 19 to each other. In addition, the semiconductor waveguide 17 provide a certain distance between the Mach-Zehnder modulator portion 15 and the laser portion 19. The distance contributes to reduces the propagation of heat from the heaters 23 of the laser portion 19 to the Mach-Zehnder modulator portion 15. Further, the groove 41 is disposed between the Mach-Zehnder modulator portion 15 and the laser portion 19. The groove 41 extends across the upper cladding layer 35b of the semiconductor waveguide 17. The groove 41 is disposed in the semiconductor waveguide 17 and the buried regions 39. The groove 41 reduces the propagation of heat from the laser portion 19. Thus, the change in the characteristics of the Mach-Zehnder modulator portion 15 by the heat is avoided. The groove 41 does not extend across the core layer 35c but does extend across the upper cladding layer 35b. With this configuration, the optical loss caused by the groove 41 is suppressed.

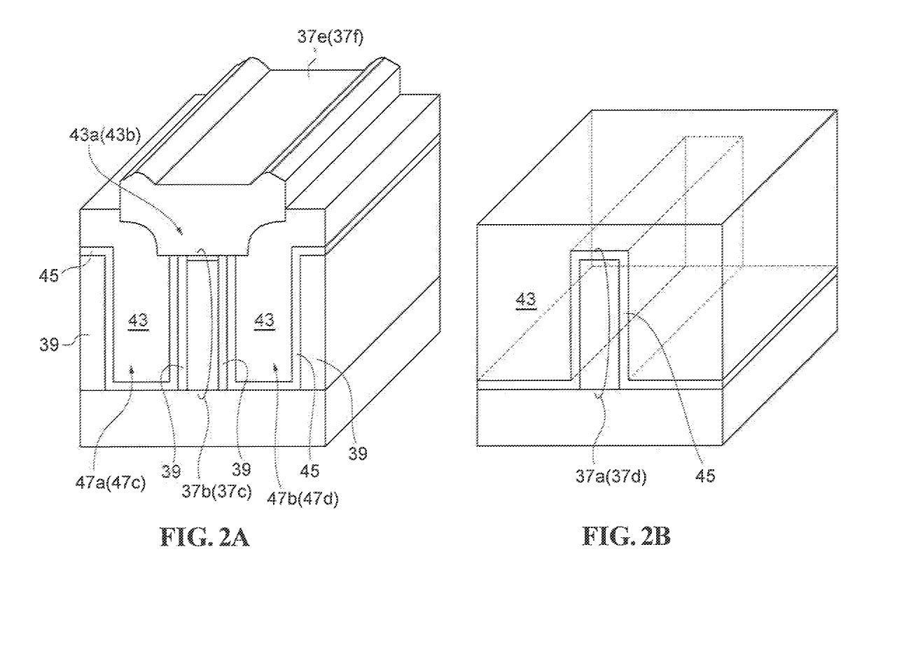

As illustrated in FIGS. 2A and 2B, the waveguide structures in the Mach-Zehnder modulator portion 15, the semiconductor waveguides 17 and the laser portion 19 is covered with an inorganic film as a protective film 45. For example, the inorganic film is silicon dioxide.

In the semiconductor optical integrated device 11, the bottom surface of the groove 41 includes the upper surface of the core layer 35c of the semiconductor waveguide 17. The groove 41 has a depth that reaches the upper surface of the core layer 35c. As a result of the groove 41 having this depth, the amount of the heat propagating from the heaters 23 to the Mach-Zehnder modulator portion 15 may be decreased.

In the present embodiment, the resin body 43 is disposed in the groove 41. The resin body 43 has a lower refractive index than the core layer 35c. The resin body 43 has a lower thermal conductivity than the buried regions 39. According to this semiconductor optical integrated device 11, the resin body 43 in the groove 41 suppresses the increase in optical loss due to the absence of the cladding layer.

FIGS. 2A and 2B are views illustrating the buried structures in the MMI couplers and the arm waveguides in the Mach-Zehnder modulator portion. FIG. 2B illustrates a portion of the MMI coupler in the region indicated with broken line BOX 1 in FIG. 1A. FIG. 2A illustrates a portion of the arm waveguide in the region indicated with broken line Box 2 in FIG. 1A. As illustrated in FIGS. 1 and 2B, the Mach-Zehnder modulator portion 15 is such that the first MMI 37a and the second MMI 37d are not buried in the buried regions 39 but are buried with the resin body 43. Thus, the MMI couplers maintain the dimensional accuracy defined by the dry etching process. The performance of the MMI couplers is maintained by utilizing this dimensional accuracy and the difference in refractive index between the semiconductors in the MMI couplers and the resin body used for the burying. As illustrated in FIGS. 1 and 2A, the Mach-Zehnder modulator portion 15 is such that the first arm 37b and the second arm 37c are buried in the buried regions 39 and are further buried with the resin body 43. In the semiconductor optical integrated device 11, the buried regions 39 include an first trench 47a and a second trench 47b. The first trench 47a and the second trench 47b each extend to define one side surface and the other side surface of the first arm 37b. Consequently, the side surfaces on both sides of the first arm 37b are covered with the buried regions 39. Further, the buried regions 39 include a third trench 47c and a fourth trench 47d. The third trench 47c and the fourth trench 47d each extend to define one side surface and the other side surface of the second arm 37c. Consequently, the side surfaces on both sides of the second arm 37c are covered with the buried regions 39.

The first electrode 37e and the second electrode 37f are connected to the first arm 37b and the second arm 37c via a first opening 43a and a second opening 43b disposed in the resin body 43, respectively.

According to this semiconductor optical integrated device 11, electricity is applied to the laser waveguides 29 of the laser portion 19 and to the first arm 37b and the second arm 37e of the Mach-Zehnder modulator portion 15. These waveguides are buried in the buried regions 39, and therefore the side surfaces of the waveguides are protected. Further, the burying of these waveguides in the buried regions 39 reduces the leak current associated with their side surfaces. One side surface and the other side surface of the first 7s arm 37b are defined by the first trench 47a and the second trench 47b, respectively. One side surface and the other side surface of the second arm $7c are defined by the third trench 47c and the fourth trench 47d, respectively. These trenches are disposed in the buried regions 39. These trenches contribute to the uniformity of the thickness of the resin body formed by application on the first arm 37h and the second arm 37c. Because the resin body is formed with a uniform thickness on top of the arms, the first opening 43a on the first arm 37b and the second opening 43b on the second arm 37c are formed with uniformity. Thus, it is possible to ensure that a plurality of Mach-Zehnder modulator portions 15 produced on a single wafer or with different production lots have uniform high-frequency characteristics.

The laser waveguides 29, the semiconductor waveguides 17, the first arm 37h and the second arm 37c are buried in the buried regions 39, whereas the first MMI 37a and the second MMI 37d are not buried in the buried regions 39. This configuration makes it possible to prevent the optical characteristics of the MMI couplers from being out of the designs defined by the dry etching process.

The buried regions 39 on the side surfaces on both sides of the first arm 37b and on the side surfaces on both sides of the second arm 37c is made of Fe-doped InP The Fe-doped InP contributes to the reduction of dark current at the first arm 37b and the second arm 37c. The thickness of the buried regions 39 on the side surfaces of the first arm 37h and the second arm 37c is preferably in the range of 0.3 μm to 0.5 μm. The thickness of 0.3 μm to 0.5 μm allows for both the reduction of dark current and the decrease in parasitic capacitance.

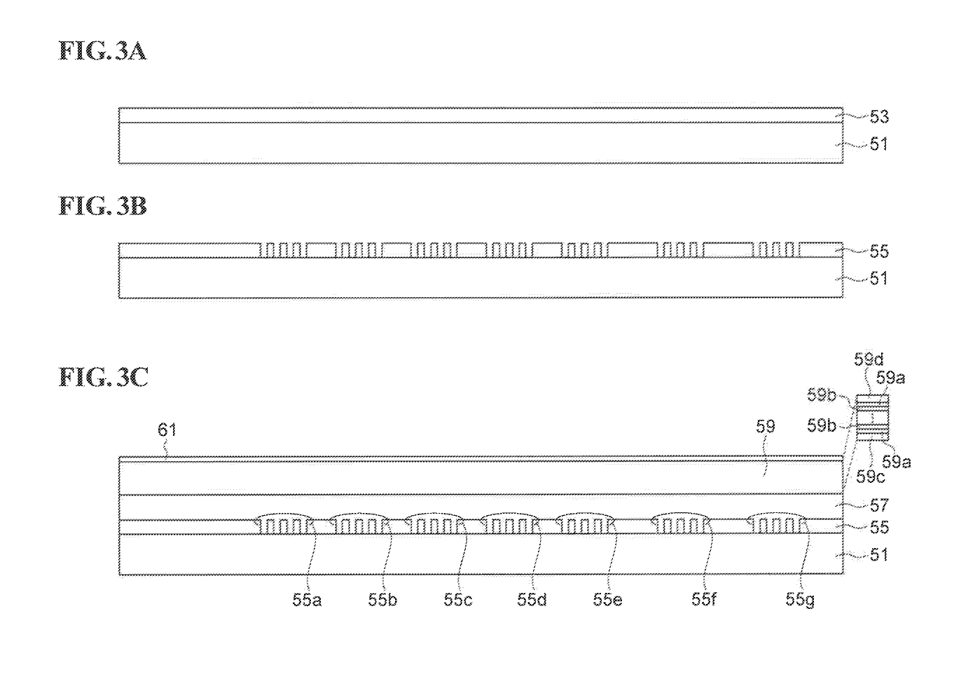

A method for manufacturing the semiconductor optical integrated device will be described with reference to FIG. 3A to FIG. 12. In an epitaxial growth step, as illustrated in FIG. 3A, a grating layer 53 is grown on a semiconductor substrate 51. For example, the semiconductor substrate 51 is an InP wafer. For the epitaxial crystal growth of semiconductors, an organo-metallic vapor phase epitaxy (OMVPE) method is used. The grating layer 53 is an n-type GaInAsP layer having a bandgap wavelength of 1.3 μm. In a grating formation step, as illustrated in FIG. 3B, the grating layer 53 is etched to fabricate a patterned grating layer 55 by lithography and dry-etching. An interference exposure method or a nano-imprint method is employed for the lithography. A reactive ion etching (RIE) method using a gas mixture of hydrocarbon and hydrogen is employed for the dry-etching. Next, an over-growth step is performed. As illustrated in FIG. 3C, a lower cladding layer 57 and an active layer 59 are grown over the patterned grating layer 55. The burying of the patterned grating layer 55 by the growth of the lower cladding layer 57 results in sampled gratings 55a to 55g. The sampled gratings 55a to 55d are arranged with a certain period, and the sampled gratings 55e to 55g are arranged with a period different from the certain period. The surface of the lower cladding layer 57 formed by the over-growth is substantially flat. On the lower cladding layer 57, the active layer 59 is grown. For example, the lower cladding layer 57 may be n-type InP. The active layer 59 includes well layers 59a and barrier layers 59h. The well layers 59a and the barrier layers 59b are arranged to form a quantum well structure. The well layers 59a include GaInAsP, and the barrier layers 59b include GaInAsP. Where necessary, the active layer 59 includes a lower optical confinement layer 59c disposed between the quantum well structure and the lower cladding layer 57. Further, the active layer 59 includes an upper optical confinement layer 59d disposed on the quantum well structure. The quantum well structure is disposed between the lower optical confinement layer 59c and the upper optical confinement layer 59d. In the present embodiment, a cap layer 61 made off semiconductor is grown on the active layer 59. For example, the cap layer 61 may be an undoped InP layer.

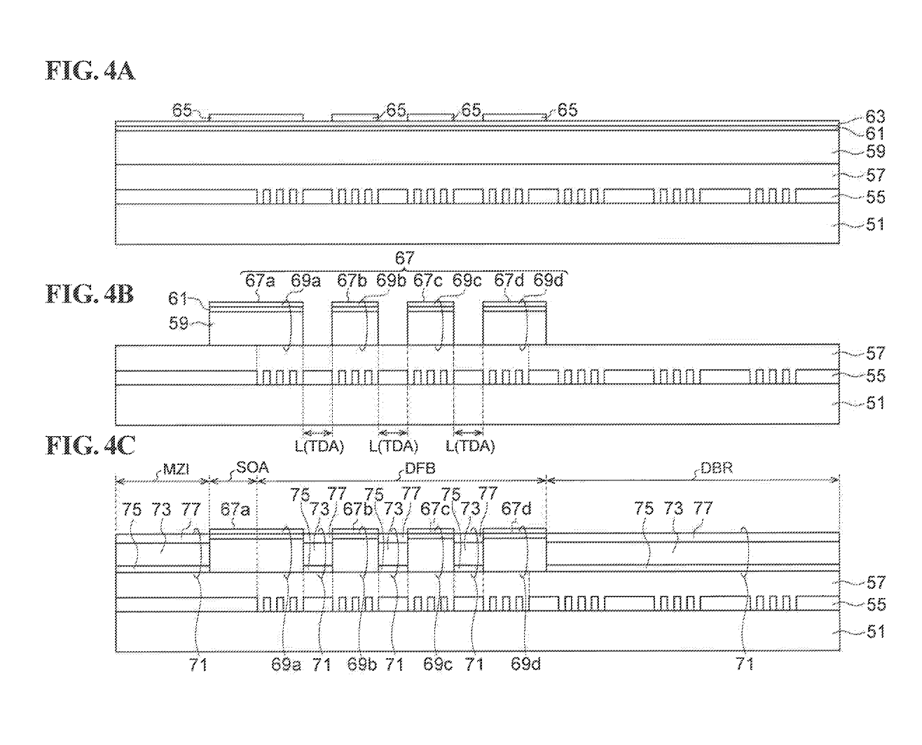

Next, a tunable distributed amplification (TDA) region is formed. As illustrated in FIG. 4A, an insulating film 63 as a mask is deposited onto the cap layer 61. For example, the insulating film 63 may be a SiN film. Next, a resist mask 65 is formed on the insulating film 63, the resist mask 65 having patterns defining the TDA region. As illustrated in FIG. 4B, the insulating film 63 is etched through the resist mask 65, thereby forming an insulating film mask 67. The mask 67 includes patterns 67a, 67b, 67c and 67d corresponding to the patterns of the resist mask 65. The cap layer 61 and the active layer 59 are etched through the mask 67 to form butt-joint mesas 69a, 69b, 69e and 69d. The butt-joint mesa 69a is provided for the SOA region and the TDA region. The butt-joint mesas 69h, 69c and 69d are provided for the TDA region. in the present embodiment, the interval between two adjacent butt-joint mesas of the butt-joint mesas 69a to 69d is L (TDA). For example, the interval L (TDA) is 150 μm. After the formation of the butt-joint mesas 69a to 69d, as illustrated in FIG. 4C, butt joint growth is performed using the mask 67 to form semiconductor stacks 71. The semiconductor stack 71 is located between two adjacent butt-joint mesas of the butt joint mesas 69a to 69d. The semiconductor stacks 71 are stacks for constituting semiconductor waveguides that change refractive index in response to the heat from heaters. For example, the butt-joint growth is performed by an OMVPE method. The semiconductor stacks 71 include a core semiconductor layer 73 for an optical waveguide. In the present embodiment, a lower semiconductor layer 75 constituting a lower cladding layer is disposed under the core semiconductor layer 73, and an upper semiconductor layer 77 constituting an upper cladding layer is disposed on the core semiconductor layer 73. In an example of the semiconductor stacks 71, the core semiconductor layer 73 is GaInAsP (bandgap wavelength: 1.4 μm), the lower semiconductor layer 75 is n-type InP, and the upper semiconductor layer 77 is undoped InP. FIG. 4C illustrates a cross section of a part corresponding to one device. An MZI region, an SOA region, a DFB region and a DBR region are arranged sequentially in the direction of the extension of waveguides (waveguiding direction). In subsequent steps, a Mach-Zehnder modulator portion 15 and semiconductor waveguides 17 are formed in the

MZI region, and a laser portion 19 is formed in the SOA region, the DFB region and the DBR region. In the SOA region and TDA region, active sections of the laser waveguide are formed from the butt-joint mesas 69a to 69d. Passive sections of the laser waveguide are formed from the semiconductor stacks 71.

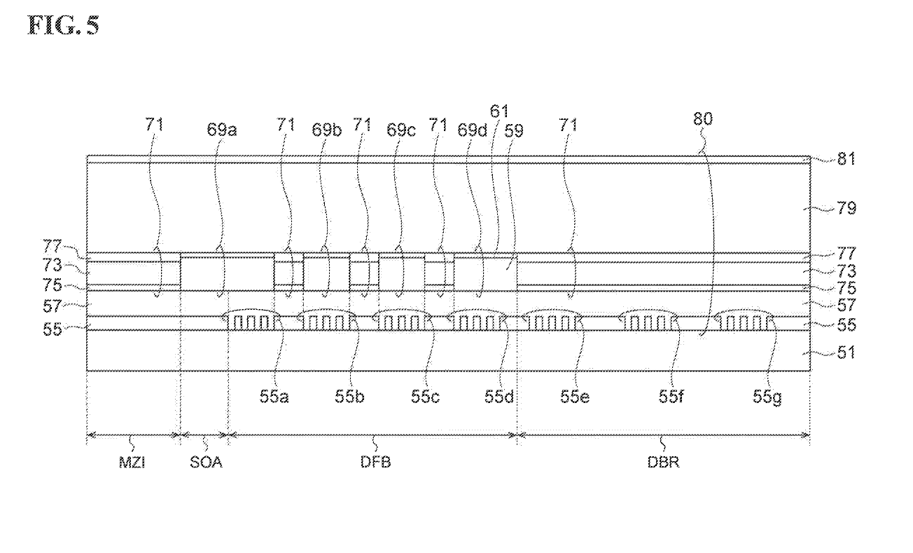

Next, after the mask 67 is removed, as illustrated in FIG. 5, an upper cladding layer 79 and a contact layer 81 are grown on the MZI region, the SOA region, the DFB region and the DBR region. Thus, a stacked semiconductor 80 is formed which includes the semiconductor layers for constituting optical waveguides.

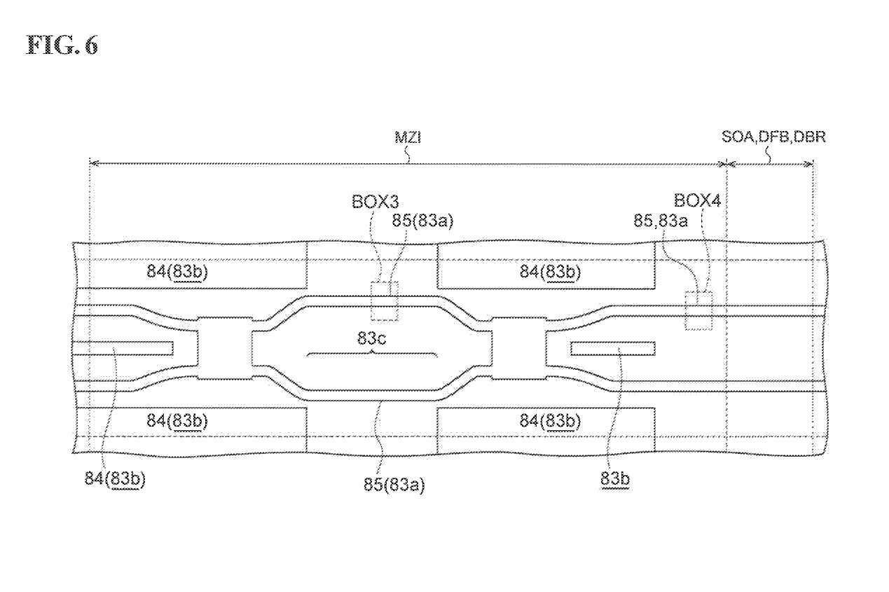

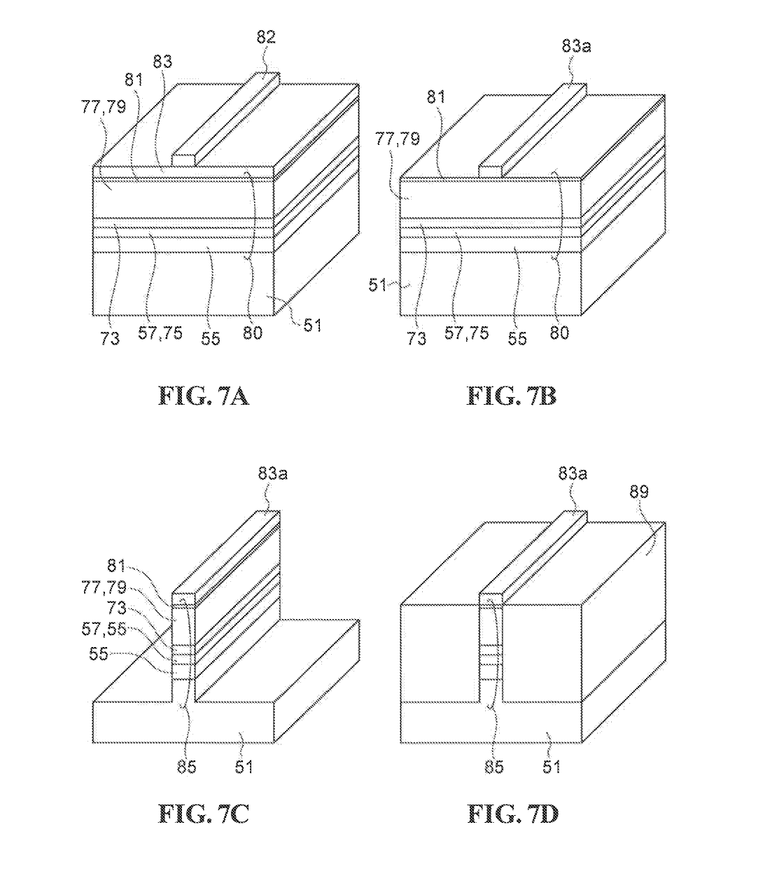

As illustrated in FIG. 6, waveguide mesas for a Mach-Zehnder modulator portion 15, semiconductor waveguides 17 and a laser portion 19 are formed in the stacked semiconductor 80, FIG. 6 corresponds to the zone of one device illustrated in FIG. 1A, The procedures for fabricating the waveguide mesas in the areas indicated with BOX 3 and BOX 4 in FIG. 6 will be described with reference to FIGS. 7A, 7B and 7C. As illustrated in FIG. 7A, an insulating film 83 is formed on the contact layer 81. For example, the insulating film 83 is a SiN film. As illustrated in FIG. 6 and FIG. 7B, the insulating film 83 is etched through a resist mask 82 to form insulating film masks 83a, 83b and an opening 83c. The mask 83a defines a waveguide pattern. The mask 83b defines a terrace pattern used to form a terrace composed of the stacked semiconductor 80. In the region where the Mach-Zehnder modulator portion 15 is formed, the mask 83a defines the opening 83c. The opening 83c is a stripe opening extending in the direction of the extension of two waveguide mesas for constituting arm waveguides. The stacked semiconductor 80 is dry-etched using the masks 83a and 83b. This etching results in waveguide mesas 85 (illustrated in FIG. 7C) and semiconductor terraces 84 (illustrated in FIG. 6). The semiconductor terraces 84 contribute to dimensional accuracy during etching in the processing of MMI couplers. In the DFB region, the waveguide mesas 85 include the sampled grating 55a (55b to 55d), the lower cladding layer 57, the active layer 59, the upper cladding layer 79 and the contact layer 81. In the DBR region, the waveguide mesas 85 include the grating layer 55, the lower cladding layer 57, the core semiconductor layer 73, the upper cladding layer 79 and the contact layer 81.

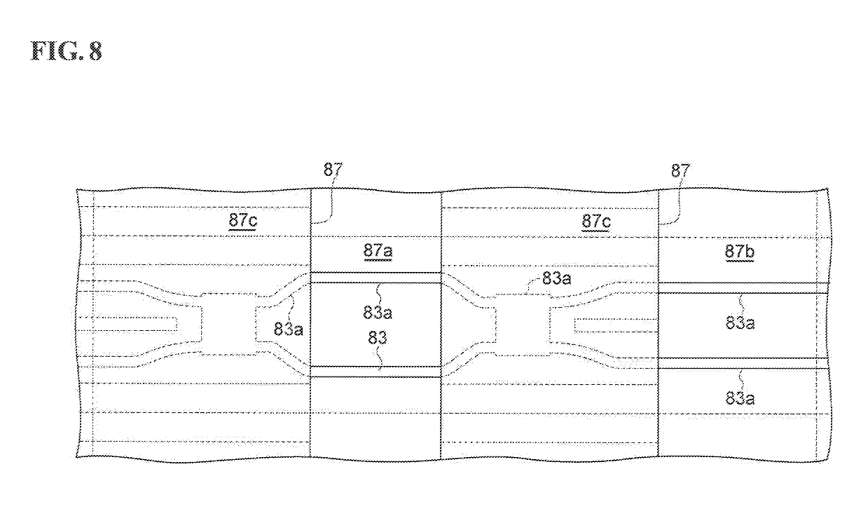

Next, as illustrated in FIG. 8, an insulating film mask 87 to form the buried semiconductor regions is formed. The buried regions are formed so as to bury the waveguide mesas for the semiconductor waveguides 17 and the laser portion 19 and a portion of the waveguide mesas for the Mach-Zehnder modulator portion 15. The mask 87 is a SiN film. The mask 87 has an opening 87a extending in a direction intersecting with the two waveguide mesas for arms of the Mach-Zehnder modulator portion 15, an opening 87b disposed in the regions for the semiconductor waveguides 17 and the laser portion 19, and stripe patterns 87c covering the MMI couplers of the Mach-Zehnder modulator portion 15. The mask 87 is formed on the insulating film mask 83a without removing the insulating film mask 83a.

After forming the mask 87, a wet etching is performed in order to remove a damaged layer generated during the dry etching of the semiconductor stack on the side surfaces of the waveguide mesas 85. The waveguide mesas 85 covered with the mask 87 are protected from this wet etching and thus maintain the shape and the dimensional accuracy defined by the dry etching, Specifically, the waveguide mesas 85 for MMI couplers are not exposed to the wet etching, whereas the waveguide mesas 85 for laser waveguides and arms are wet etched. After the wet etching, buried regions 89 are grown using the ° WIPE method, as illustrated in FIG. 7D. The buried regions 89 are grown on the openings 87a and 87b. The buried regions 89 are not grown on the insulating film mask 83a and on the patterns 87c of the mask 87. The side surfaces of the waveguide mesas 85 for the laser waveguide, the semiconductor waveguide and arms are covered with the buried regions 89. For example, the buried regions 89 are made of Fe-doped InP. After the growth of the buried semiconductor regions 89, the mask 87 is removed.

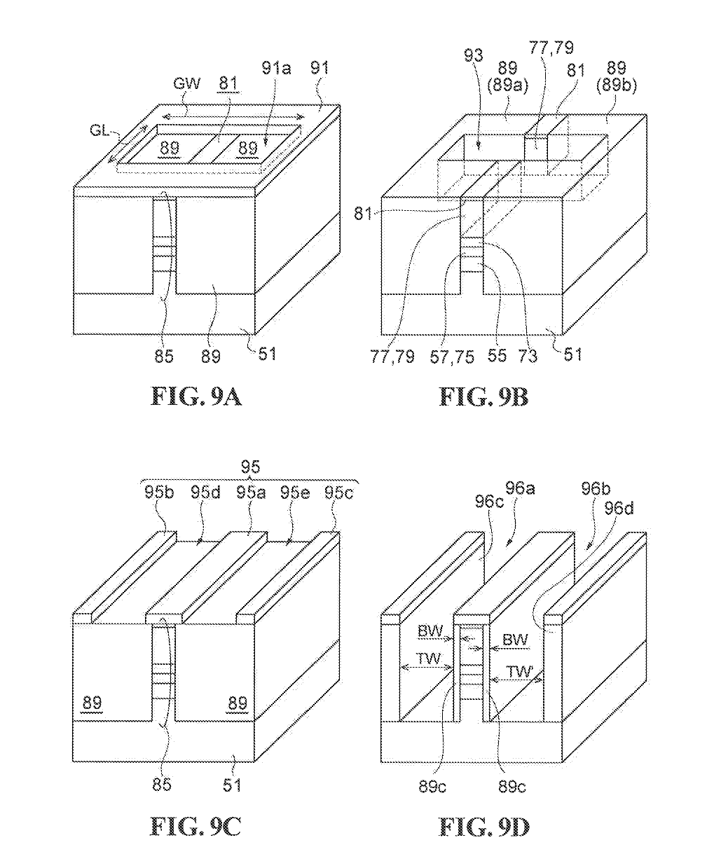

Next, there will be described steps in which a groove is formed across the semiconductor waveguide 17. After the formation of the buried regions 89, as illustrated in 9A, a mask 91 is formed on the regions for the Mach-Zehnder modulator portion 15, the semiconductor waveguides 17 and the laser portion 19. The mask 91 has an opening 91a on the waveguide mesa 85 for the semiconductor waveguide 17 and the buried regions 89. The semiconductor waveguide 17 connects the waveguide mesa 85 for the laser portion 19 to the waveguide mesa 85 for the Mach-Zehnder modulator portion 15. The opening 91a extends across the waveguide mesa 85 for the semiconductor waveguide 17, specifically, extends from the buried region 89 (89a) on one side of the waveguide mesa 85 to the buried semiconductor region 89 (89b) on the other side. As illustrated in FIG. 9B, the waveguide mesa 85 and the buried regions 89 are etched through the mask 91 to form a groove 93. The groove 93 is formed in the waveguide mesa 85 and the buried regions 89 so as to extend across the semiconductor waveguide 17. Dry etching with a chlorine etchant is adopted to form the groove 93. After forming the groove, the mask 91 is removed. The shape of the groove is as follows. The groove length GW in the direction of the extension of the waveguide (waveguiding direction) is not less than 10 μm. When the groove length is 10 μm or more, an effect of decreasing heat propagation is substantially obtained. The groove length GL is not more than 100 μm. The groove width GW in the direction across the waveguiding direction is not less than 10 μm. When the groove width is 10 μm or more, heat propagation may be effectively decreased. The groove width GW is not more than 100 μm. With the groove width being 100 μm or less, a resin body may be provided in the groove while reducing the probability that the resin body in the groove is separated. The resin body is a BCB resin. In the present embodiment, the etching for the formation of the groove 93 is stopped at the upper surface of the core semiconductor layer 73. Thus, the core semiconductor layer 73 is exposed on the bottom surface, of the groove 93.

After the formation of the buried regions 89, trenches are formed in the buried regions 89. The trenches extend along the arm waveguides of the Mach-Zehnder modulator portion 15. The formation of the trenches is described with reference to FIGS. 9C and 9D. As illustrated in FIG. 9C, a mask 95 is formed on the waveguide mesa 85 and the buried regions 89. The mask 95 has a first pattern 93a, a second pattern 95b, a third pattern 95c, a first opening 95d and a second opening 95e. The first pattern 95a extends along the waveguide mesa 85. The second pattern and the third pattern are arranged away from the first pattern 95a so that the widths of the trenches are defined. The first opening 95d and the second opening 93e define the trenches. The first pattern 95a extends beyond both edges of the upper surface of the waveguide mesa 85. When the trenches have been formed, the buried regions 89 will remain as covering layers 89c on both sides of the waveguide mesa 85 under these overhang portions of the pattern. That is, the side surfaces of the waveguide mesa 85 are covered with the semiconductors of the buried regions 89. The covering layers 89c contribute to the reduction of leak current passing through the side surfaces of the arm waveguide to which modulation electrical signals are applied.

As illustrated in FIG. 9D, the buried regions 89 are etched through the mask 95, By this etching, trenches 96a and 96b extending along the waveguide mesa 85 for the arm are formed. The formation of the trenches 96a and 96b also results in the formation of the covering layers 89c on the side surfaces of the waveguide mesa 85, and buried semiconductor terraces 96c and 96d.

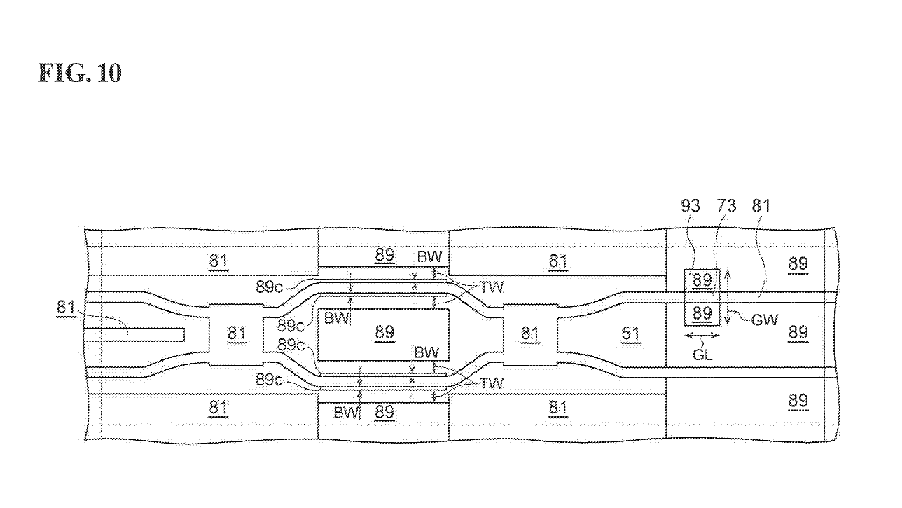

FIG. 10 is a plan view after the formation of the groove 93 and the trenches 96a and 96h. The positions of the trenches 96a and 96b are determined such that the covering layers 89c are formed on the side surfaces of the waveguide mesa 85. The widths of the trenches 96a and 96b are regulated to control the thickness of a resin body that will be formed on the waveguide mesa 85. The trench widths TW of the trenches 96a and 96b are 3μm or more and a 100 μm or less. For example, the width of the trench 96a adjacent to the waveguide mesa 85 for the arm waveguide is preferably the same as the width of the trench 96b except for production variations. When such substantially equivalent trenches are formed on both sides of the waveguide mesa 85, variations in the thickness of a resin body that is formed on the waveguide mesa 85 are reduced. For example, in a semiconductor modulator that is a multi-level modulation type including a plurality of Mach-Zehnder modulators in a single device area, the decrease in thickness variations makes it possible to avoid variations of modulation frequency bands between the Mach-Zehnder modulators.

With reference to specific examples, there will be described the reasons why the variations of modulation frequency bands are reduced. When the widths of the trenches 96a and 96b on both sides of the waveguide mesas 85 are the same as or similar to each other, the thickness of resin bodies extending from the trench 96a to the trench 96b over the waveguide mesa 85 (the thickness from the upper surface of the waveguide mesa 85 as the reference) is allowed to be uniform between the arm waveguides and also between the Mach-Zehnder modulators. An opening is formed in the resin body on the arm waveguide for the establishment of an electrical connection to the arm waveguide. When the thickness of the resin bodies on the waveguide mesas is uniform, the openings are formed by etching so as to ensure small variations in the opening size. Thus, variations of bands between the arm waveguides and between the Mach-Zehnder modulators are reduced. Further, the buried semiconductor terraces 96c and 96d serve as a help to control the areas to be buried with the resin body. This control of the area can substantially eliminate the occurrence of the separation of the resin body. The buried semiconductor may be semi-insulating InP (Fe-doped 10). The use of semi-insulating InP makes it possible to decrease the influence of the buried semiconductor layers on high-frequency characteristics. Thus, the buried semiconductor terraces 96c and 96d may be disposed close to the waveguide mesa 85.

For example, the thickness of the covering layer 89c on the side surface of the waveguide mesa 85, namely, the buried width BW may be in the range of 0.3 μm to 0.5 μm. The semiconductor burying with a thickness of 0.3 μm or more reduces dark current.

Further, the semiconductor burying with a thickness of 0.5 μm or less ensures that an increase in parasitic capacitance is avoided.

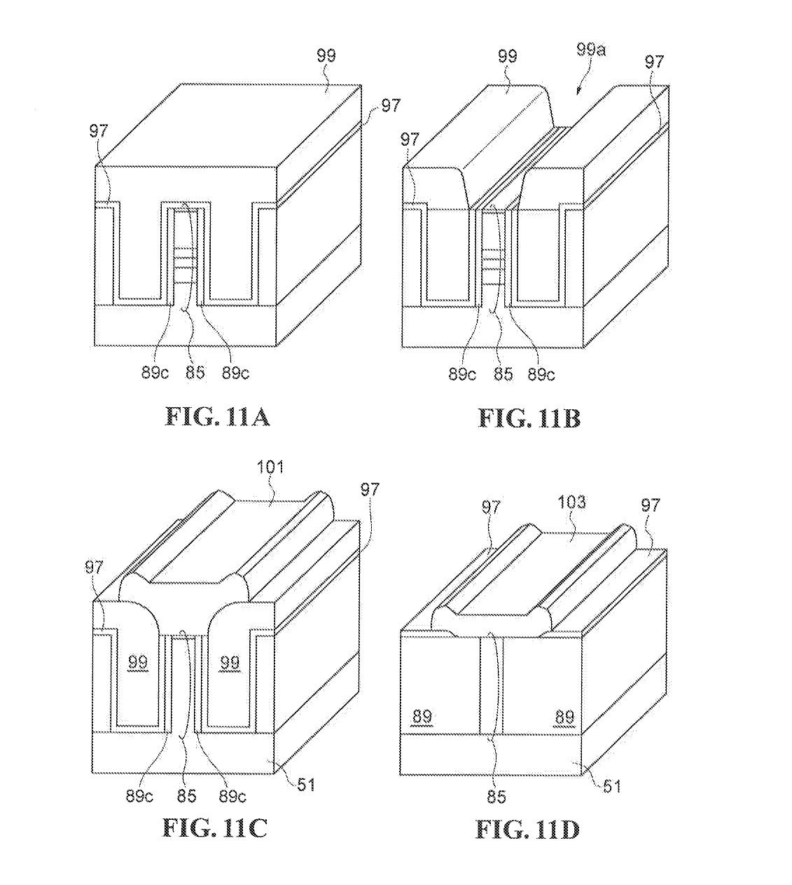

After the formation of the trenches 96a and 96b, as illustrated in FIG. 11A, an insulating film 97 as a protective film is deposited onto the entire surface. A resin is applied onto the insulating film 97, thereby forming a resin body 99. The resin body 99 buries the waveguide mesa 85, and the buried regions 89 including the trenches 96a and 96b and the buried semiconductor terraces 96c and 96d. The surface of the resin body 99 is substantially flat. For example, the resin body 99 is a BCB resin. The resin body 99 is also disposed in the groove 93. When the resin body 99 has a lower refractive index than the semiconductor of the core semiconductor layer 73, it is possible to reduce the decrease in optical characteristics due to the groove 93 extending across the upper cladding layer 79 made of a semiconductor. The BCB resin has a lower refractive index than the semiconductor of the core semiconductor layer 73. Further, the BCB resin has a lower thermal conductivity than the semiconductor of the buried semiconductor regions 89.

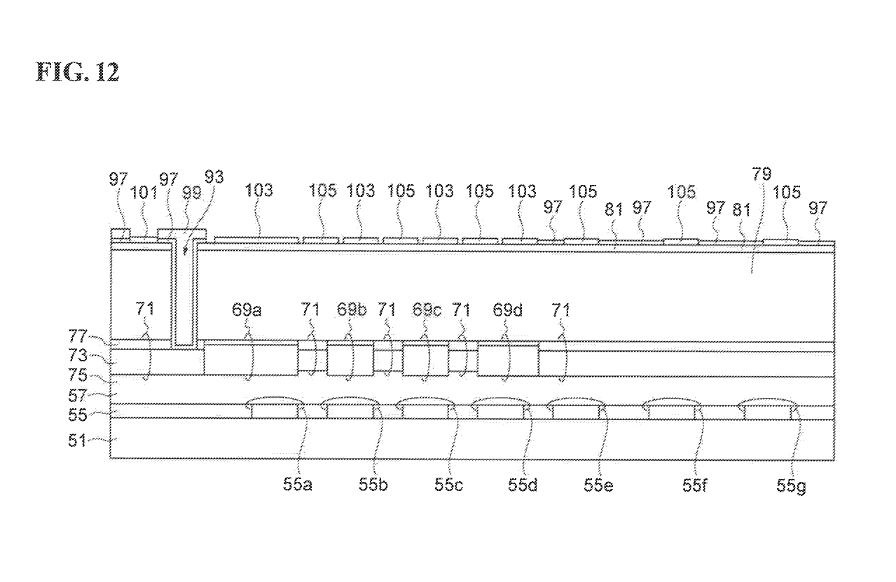

The resin body 99 on the device area for the laser portion 19 is removed by photolithography and an etching technique. After the formation of the resin body 99, as illustrated in FIG. 11B, an opening is formed in the resin body 99 on the waveguide mesa 85 for the arm waveguide, and in the insulating film 97. By virtue of the controlling of the widths of the trenches 96a and 96b, the thickness of the resin bodies 99 on the waveguide mesas 85 for the arm waveguides is substantially uniform. Therefore, there is no need to adjust the etching conditions with respect to the waveguide mesas in accordance with the thickness of the resin body 99. That is, the openings may be formed in the resin bodies 99 without any complicated procedures. To form the opening, the resin body 99 and the insulating film 97 are treated by photolithography and etching. After the opening is formed, as illustrated in FIG. 11C, an electrode 101 is formed on the upper surface of the waveguide mesa 85 for the arm waveguide. Further, as illustrated in FIG. 11D and FIG. 12, electrodes 103 and heaters 105 are formed in the device area for the laser portion 19. Specifically, after the formation of the openings in the insulating film 97, electrodes 103 are formed on the upper surface of the waveguide mesas 85 for the laser portion 19 (the butt joint mesas 69a to 69d) and further heaters 105 are formed on the semiconductor stacks 71.

Through the aforementioned steps, the semiconductor optical integrated devices are manufactured.

### EXAMPLE

First, crystals are grown on an n-type InP substrate by an OMVPE method to form an n-type InP buffer layer and an n-type GaInAsp grating layer (bandgap wavelength: 1300 nm). Next, the n-type GaInAsP grating layer is treated by an interference exposure method or a nano-imprint method to form a pattern of gratings. The n-type GaInAsP grating layer is etched by dry etching using CH₄/H₂ gas. This processing results in sampled gratings. After this formation, the patterned n-type GaInAsp grating layer is buried with InP by crystal growth using an OMVPE method. Subsequently, an n-type GaInAsP optical confinement layer (bandgap wavelength: 1200 nm), an undoped GaInAsP quantum well multilayer structure, an undoped optical confinement layer (bandgap wavelength: 1200 nm) and an undoped InP cap layer are grown. The quantum well multilayer structure has a bandgap wavelength of 1.55 μm and includes well layers and barrier layers. For example, the well layers include undoped GaInAsP having a thickness of 5 nm, and the barrier layers include undoped GaInAsP having a thickness of 10 nm.

A mask for the formation of butt-joints is formed. The mask includes SiN. The SiN film is deposited by a chemical vapor deposition (CVD) method. The thickness of the SiN film is 200 nm. The mask pattern for the formation of butt-joints is formed by photolithography and wet etching. The wet etching is performed using buffered hydrofluoric acid (BHF). Butt-joint mesas are formed by HCl wet etching through the patterned SiN mask, During the etching of the n-type GaInAsp optical confinement layer, the InP buffer layer disposed under the n-type GaInAsp optical confinement layer serves as an etching-stop layer. Next, an n-type InP layer, an undoped GaInAsP layer (bandgap wavelength: 1400 nm) and an undoped InP layer are grown while the SiN mask used for the formation of butt-joint mesas is used as a selective growth mask. These layers are used as waveguides for a distributed Bragg reflector (DBR), waveguides for a tunable distributed amplification (TDA) region, and waveguides for a Mach-Zehnder (MZ) modulator.

After the SiN mask used for the formation of butt-joint mesas is removed with BHF, a p-type InP cladding layer (thickness: 1500 nm) and a p-type GaInAs contact layer (thickness: 300 nm) are grown.

After these layers are grown, a SiN film (thickness: 300 nm) is deposited by a CVD method. The SiN film is treated by photolithography and etching (RIE using CF₄ gas) to form a SiN waveguide mask defining a pattern of waveguides. Through the SiN waveguide mask, RIE is performed using Cl₂ gas to form semiconductor mesa stripes.

Without removing the SiN waveguide mask, a SiN film (thickness: 200 nm) is deposited by a CVD method over the entire surface. The SiN film is processed into a regrowth mask by photolithography and etching with BHF. The regrowth mask covers the entirety of the regions for MMI couplers of the MZ modulator. With use of the regrowth mask, selective growth is performed to bury the arm waveguides for the MZ modulator and the laser waveguides for the wavelength-tunable laser diode. To realize this burying, the regrowth mask has openings through which the side surfaces of the arm waveguides for the MZ modulator and the side surfaces of the laser waveguides for the wavelength-tunable laser diode are accessible. Here, the SiN waveguide mask is still disposed while covering the upper surface of these waveguides. Subsequently, a damaged layer that has been generated by the dry etching is removed by wet etching with an HCl etchant. After the treatment, Fe-InP is regrown by an OMVPE method to bury the semiconductor stacks. Subsequently, the regrowth mask is removed with BHF.

Subsequently, a SiN film (thickness: 300 nm) is formed by a CVD method. The SiN film is treated by photolithography and CF₄ dry etching to form a SiN groove mask defining the shape of a groove. Through the SiN groove mask, the semiconductor waveguide and the Fe-InP buried regions are etched by RIE using Cl₂ gas. As a result, a groove is formed in the semiconductor waveguide and the Fe-InP buried regions. This groove is provided to prevent the heat from the wavelength tunable. laser portion from affecting the MZ modulator. The etching is stopped when the groove reaches a depth immediately above the core layer in the semiconductor waveguide. Plasma monitoring is used to stop the etching at this depth. In the etching step, the wavelength-tunable laser portion and the MZ modulator region are covered with the SiN groove mask.

Trenches are formed in order to reduce the parasitic capacitance of the arm waveguides for the MZ modulator. For the formation of trenches, a SiN mask which defines the shape of the trench structures is formed by depositing a SiN film (thickness: 300 nm) over the entire surface by a CVD method and treating the SiN film by photolithography and CF₄ dry etching. Through the SiN mask, the Fe-InP buried layers are etched by RIE using Cl₂ gas to form trenches. During this step, the wavelength-tunable laser portion and the groove are covered with the SiN mask.

After the trenches are formed in the Fe-InP buried regions of the MZ modulator region, a silicon dioxide film (thickness: 300 nm) is deposited to passivate the entire device. Further, a BCB resin is applied over the entire surface of the device for planarization. Subsequently, the BCB resin in the wavelength-tunable laser portion is removed by photolithograph) and dry etching with CF₄/O₂ gas.

Contact openings are formed in the BCB resin on the arm waveguides for the MZ modulator by photolithography and dry etching with CF₄/O₂ gas. During this etching, the MIMI coupler regions, the wavelength-tunable laser portion and the groove are covered with a resist mask. In the contact openings, the contact layers for contact with ohmic electrodes are exposed. P-Side and n-side ohmic electrodes are formed on the arm waveguides for the MZI modulator and on the wavelength-tunable laser portion.

In this Example, the side surfaces of the arm waveguide mesas for the MZ modulator are buried in Fe-InP. Further, trenches are disposed in the Fe-InP buried regions in which the arm waveguides for the MZ modulator are buried. Furthermore, the trenches are buried with BCB resin. With this structure, the MZ modulator and the wavelength-tunable laser achieve high reliability and good high-frequency characteristics. Further, the groove disposed between the wavelength-tunable laser and the MZ modulator prevents the phase variations of the MZ modulator from being destabilized by the heat generated by the wavelength tuning of the wavelength-tunable laser.

While preferred embodiments have been discussed above while illustrating the principle of the present invention, those skilled in the art will appreciate that various modifications may be made to the configurations and the details discussed above without departing from the principle of the invention. The scope of the invention is not limited to any specific configurations disclosed in the embodiments. Therefore, the features defined in the appended claims and all modifications and alterations which are within the spirit of the invention are claimed.

What is claimed is:

1. A semiconductor optical integrated device comprising:
a substrate having a principal surface including a first area, a second area and a third area arranged in a waveguiding direction;
a laser portion disposed on the third area of the substrate, the laser portion including a laser waveguide that includes an active section configured to generate light and a passive section including a heater thereon;
a semiconductor waveguide disposed on the second area of the substrate, the semiconductor waveguide including a core layer and a cladding layer disposed on the core layer;
a Mach-Zehnder modulator portion disposed on the first area of the substrate, the Mach-Zehnder modulator portion including a first MMI coupler, a first arm, a second arm, a second MMI coupler, a first electrode and a second electrode;
a buried region embedding the laser waveguide, the semiconductor waveguide, and the first and second arms of the Mach-Zehnder modulator portion;
a groove disposed on the second area of the substrate, the groove extending in a direction intersecting the waveguiding direction to across the semiconductor waveguide to the buried region; and
a resin body disposed on the Mach-Zehnder modulator portion,
wherein the laser portion is optically coupled to the Mach-Zehnder modulator portion via the semiconductor waveguide, and
the groove has a bottom on a surface of the core layer of the semiconductor waveguide.

2. The semiconductor optical integrated device according to claim 1, wherein
the first MMI coupler is optically coupled to one end of the first arm and one end of the second arm,
the second MMI coupler is optically coupled to the other end of the first arm and the other end of the second arm,
the buried region includes a first trench and a second trench, the first trench and the second trench each defining one side surface and the other side surface of the first arm,
the buried region includes a third trench and a fourth trench, the third trench and the fourth trench each defining one side surface and the other side surface of the second arm, and
the first electrode and the second electrode are connected to the first arm and the second arm via a first opening and a second opening in the resin body, respectively.

3. The semiconductor optical integrated device according to claim 1, wherein
the buried region is made of Fe-doped InP.

4. The semiconductor optical integrated device according to claim 1, wherein
each of the first and second arms includes a side surface, and
the buried region on the side surfaces of the first and second arms has a thickness of 0.3 μm to 0.5 μm.

5. The semiconductor optical integrated device according to Claim 1, wherein
the first MMI coupler and the second MMI coupler of the Mach-Zehnder modulator portion are buried with the resin body.

6. The semiconductor optical integrated device according to claim 1, wherein
the bottom of the groove reaches an upper surface of the core layer of the semiconductor waveguide.

7. The semiconductor optical integrated device according to claim 1, wherein
the resin body has a lower refractive index than a refractive index of the core layer,
the resin body has a lower thermal conductivity than a thermal conductivity of the buried regions, and
the resin body is disposed in the groove.
